(19) United States
(12) Patent Application Publication
(10) Pub. No.: US 2023/0086261 A1
(43) Pub. Date: Mar. 23, 2023

(54) CLUSTERING DEVICE, CLUSTERING METHOD, AND CLUSTERING PROGRAM

(71) Applicant: Nippon Telegraph and Telephone Corporation, Tokyo (JP)

(72) Inventors: Jumpei YAMASHITA, Musashino-shi, Tokyo (JP); Hidetaka KOYA, Musashino-shi, Tokyo (JP)

(21) Appl. No.: 17/801,779

(22) PCT Filed: Feb. 25, 2020
(86) PCT No.: PCT/JP2020/007540

§ 371 Date: Aug. 23, 2022

(51) Int. Cl. G06N 3/0475; G06N 3/088

(52) U.S. Cl. CPC G06N 3/0475; G06N 3/088

(57) ABSTRACT

The clustering apparatus constructs, on assumption that sensor data is generated from a latent variable which is a consecutive random variable of the number of dimensions suitable for handling in the shallow method, a model for estimating the latent variable from the sensor data, based on a generative model for generating the sensor data from the latent variable. Next, the clustering apparatus calculates, from the sensor data, an estimated value of the latent variable from which the sensor data is generated, by using the constructed model. The clustering apparatus then clusters the calculated estimated values of the latent variable by the shallow method, and identifies the optimum number of clusters. Thereafter, the clustering apparatus performs clustering of the sensor data by a neural network having three or more layers, by using the hyperparameter information of the constructed model and the identified optimum number of clusters.

### TECHNICAL FIELD

The present invention relates to a clustering apparatus, a clustering method, and a clustering program.

### BACKGROUND ART

For example, in analyzing multi-dimensional data, such as the sensor data output by inertial sensors (for example, accelerometers, rotation amount meters, etc.) and physiological signal measurement sensors, it is necessary to reduce the dimensionality of the data to help understand what the data represents.

A method of reducing the dimensionality of data is clustering. During clustering, data is divided into several clusters, based on similarity between data, and the number of dimensions of the data is reduced to the number of clusters, based on the results of clustering of the data.

Here, related clustering methods include the so-called shallow method and the deep method. The above-described shallow method is, for example, simple unsupervised learning or a method that utilizes a neural network having two or less layers. The deep method is, for example, a method that utilizes a neural network having three or more layers.

### CITATION LIST

### Non Patent Literature

NPL 1: Balanced Self-Paced Learning for Generative Adversarial Clustering Network (CVPR 2019), [Search on Feb. 7, 2020]; Internet <URL: http://openaccess.thecvf.com/content_CVPR_2019/papers/Ghasedi_Balanced_Self-Paced_Learning_for_Generative_Adversarial_Clustering_Network_CVPR_2019_paper.pdf>

### SUMMARY OF THE INVENTION

### Technical Problem

In the shallow method described above, less computations are needed to learn the model required for clustering, but the clustering performance degrades with an increase in the number of dimensions. Thus, the clustering of non-linear and complex multi-dimensional data is difficult to perform with the shallow method, unfortunately.

On the other hand, the deep method enables clustering of multi-dimensional data. However, the number of clusters is to be determined manually in advance and then the model required for clustering needs to be learned, and as a result, trial and error is required to find the appropriate number of clusters. In addition, many computations are involved in learning the model required for the clustering described above, because the computations required to find the appropriate number of clusters become very large.

Thus, an object of the present invention is to solve the above-described difficulties and perform appropriate clustering with less computations for sensor data being multi-dimensional data.

### Means for Solving the Problem

In order to solve the problems described above, a clustering apparatus according to the present invention includes: a model construction unit configured to construct, on assumption that sensor data is generated from a latent variable, a model for estimating the latent variable from the sensor data, based on a generative model for generating the sensor data from the latent variable, the latent variable being a consecutive random variable of the number of dimensions suitable for handling in unsupervised learning or a neural network having two or less layers; a latent variable calculation unit configured to calculate, from the sensor data, an estimated value of the latent variable from which the sensor data is generated, by using the constructed model; a number-of-clusters identification unit configured to identify the number of clusters when a plurality of the calculated estimated values of the latent variable are clustered by unsupervised learning or a neural network having two or less layers; a hyperparameter information acquisition unit configured to acquire hyperparameter information of the constructed model; and a clustering unit configured to cluster the sensor data by a neural network having three or more layers, by using the acquired hyperparameter information and the identified number of clusters.

### Effects of the Invention

According to the present invention, it is possible to perform appropriate clustering with less computations for sensor data being multi-dimensional data.

### BRIEF DESCRIPTION OF DRAWINGS

FIG. 1 is a diagram illustrating a configuration example of a clustering apparatus.

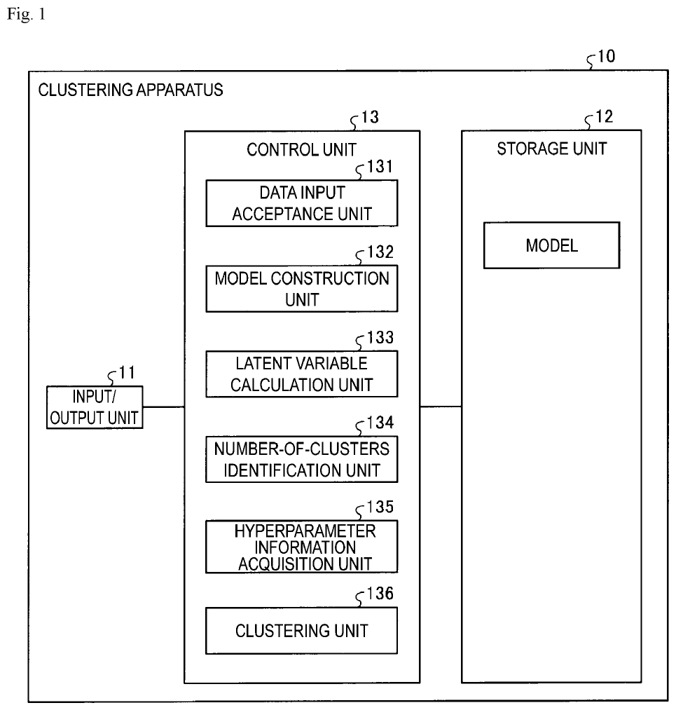

FIG. 2 is a flowchart illustrating an example of a processing procedure of the clustering apparatus in FIG. 1.

FIG. 3 is a diagram for explaining a relationship between latent variables and data (sensor data).

FIG. 4 is a diagram for explaining a GAN.

FIG. 5 is a diagram for explaining an InfoGAN.

FIG. 6 is a diagram for explaining a VAE.

FIG. 7 is a diagram for explaining clustering of a latent variable by a shallow method.

FIG. 8 is a diagram illustrating a configuration example of a computer executing a clustering program.

### DESCRIPTION OF EMBODIMENTS

Hereinafter, modes (embodiments) of the present invention will be described with reference to the drawings. Note that the present invention is not limited to the embodiments described below.

Note that in the following description, the sensor data to be processed by the clustering apparatus 10 is, for example, data that is sensed by an action of a human body. The sensor data is, for example, any one or a combination of physiological data of the human body, acceleration data indicating a movement of the human body, and rotation amount data indicating a movement of the human body. The sensor data is multi-dimensional data, for example, data of approximately several thousands of dimensions.

In the description below, the shallow method is, for example, simple unsupervised learning or a method that utilizes a neural network having two or less layers, and the deep method is, for example, a method that utilizes a neural network having three or more layers.

### Configuration Example

The clustering apparatus 10 performs clustering of the input sensor data. The clustering apparatus 10 includes an input/output unit 11, a storage unit 12, and a control unit 13.

The input/output unit 11 inputs and outputs various types of data. For example, the input/output unit 11 accepts input of sensor data and outputs the result of clustering of sensor data. The input/output unit 11 is realized by an input/output interface, a communication interface, or the like.

The storage unit 12 is realized by a semiconductor memory element such as a random access memory (RAM) or a flash memory, or a storage apparatus such as a hard disk or an optical disk, and a processing program for causing the clustering apparatus 10 to operate, data used during execution of the processing program, and the like are stored in the storage apparatus. Further, the storage unit 12 stores a model constructed by the control unit 13, the hyperparameter information of the model, and the like. The model constructed by the control unit 13 is described below.

The control unit 13 is responsible for controlling the entire clustering apparatus 10. The control unit 13 includes an internal memory for storing programs that define various processing procedures or the like and required data, and executes various types of processing using the programs and the data. For example, the control unit 13 is an electronic circuit such as a central processing unit (CPU) or a micro processing unit (MPU). The control unit 13 functions as various processing units by the operation of various programs.

The control unit 13 includes a data input acceptance unit 131, a model construction unit 132, a latent variable calculation unit 133, a number-of-clusters identification unit 134, a hyperparameter information acquisition unit 135, and a clustering unit 136.

The data input acceptance unit 131 accepts an input of sensor data via the input/output unit 11.

The model construction unit 132 constructs a model that estimates a latent variable from the sensor data. For example, the model construction unit 132 constructs, on assumption that the latent variable is a consecutive random variable of the number of dimensions that can be handled by the shallow method (for example, a random variable based on normal distribution), a model for estimating the latent variable from the sensor data, based on a generative model for generating the sensor data from the latent variable.

The generative model described above is a model that is trained to generate sensor data from a latent variable by unsupervised learning. The generative model is, for example, Generative Adversarial Networks (GAN), Information Maximizing Generative Adversarial Networks (InfoGAN), Variational AutoEncoder (VAE), and the like. The details of construction of a model by the model construction unit 132 described above will be explained later with specific examples.

The latent variable calculation unit 133 calculates, from the sensor data, an estimated value of the latent variable from which the sensor data is generated, by using the model constructed by the model construction unit 132.

The number-of-clusters identification unit 134 clusters the estimated values of the latent variable calculated by the latent variable calculation unit 133, by the shallow method, and identifies the optimum number of clusters.

For example, the number-of-clusters identification unit 134 uses an elbow method to identify the above-described optimum number of clusters. Note that the elbow method is, for example, a method in which the K-means method or the like is tried out based on various numbers of clusters, a point beyond which the accuracy does not increase much even after further increasing the number of clusters is searched, and the number of clusters resulted from the search is identified as the optimum number of clusters.

The hyperparameter information acquisition unit 135 acquires the hyperparameter information (for example, the number of units of the neural network, the connection scheme, the learning rate, and the like) of the model constructed by the model construction unit 132.

The clustering unit 136 performs clustering of the sensor data by the deep method, by using the hyperparameter information acquired by the hyperparameter information acquisition unit 135 and the optimum number of clusters identified by the number-of-clusters identification unit 134.

For example, the clustering unit 136 clusters the sensor data into the above-described optimum number of clusters by using a neural network having three or more layers in which all hyperparameters excluding the final layer of the network architecture are the same as the hyperparameters of the model constructed by the model construction unit 132. Thereafter, the clustering unit 136 outputs the result of clustering of the sensor data via the input/output unit 11.

In this way, the clustering apparatus 10 is capable of performing appropriate clustering with less computations for sensor data being multi-dimensional data.

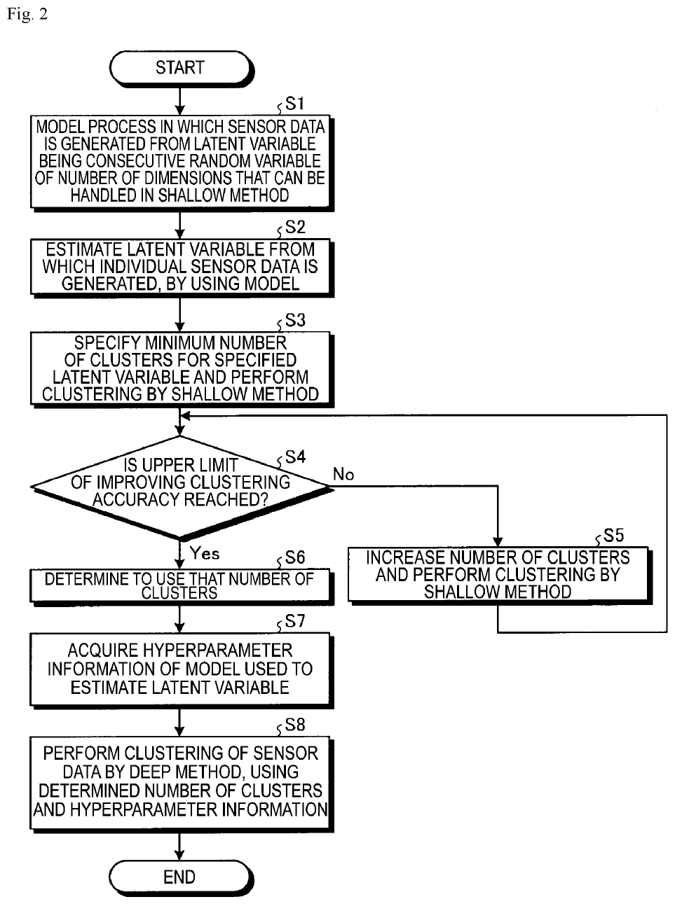

Processing Procedure Next, an example of a processing procedure of the clustering apparatus 10 will be described with reference to FIG. 2.

First, when the data input acceptance unit of the clustering apparatus 10 accepts an input of sensor data via the input/output unit 11, the model construction unit 132 models the process in which sensor data is generated from a latent variable being a consecutive random variable of the number of dimensions that can be handled in the shallow method (S1).

Next, the latent variable calculation unit 133 estimates a latent variable from which the individual sensor data is generated, by using the model obtained in S1 (S2). Thereafter, the number-of-clusters identification unit 134 specifies the minimum number of clusters for the latent variable estimated in S2 and performs clustering by the shallow method (S3). Then, if the number-of-clusters identification unit 134 determines that the clustering accuracy does not improve further by changing the number of clusters (Yes in S4), the number-of-clusters identification unit 134 determines that number of clusters as the number of clusters used for the clustering of the sensor data (S6).

On the other hand, if the number-of-clusters identification unit 134 determines in S4 that the clustering accuracy improves further by changing the number of clusters (No in S4), the number-of-clusters identification unit 134 increases the number of clusters, performs clustering by the shallow method (S5), and returns to the processing in S4.

After S6, the hyperparameter information acquisition unit 135 acquires the hyperparameter information of the model used to estimate the latent variable in S2 (S7). Thereafter, the clustering unit 136 performs clustering of the sensor data by the deep method, by using the number of clusters determined in S5 and the hyperparameter information acquired in S7 (S8).

The clustering apparatus 10 makes it possible to identify the optimum number of clusters of the sensor data without repeating several times the learning process of a neural network that requires relatively more computations. As a result, the clustering apparatus 10 is capable of performing appropriate clustering with less computations for the sensor data.

Model Construction

Next, the construction of a model by the model construction unit 132 will be described in detail. Firstly, the relationship between latent variables and sensor data will be described.

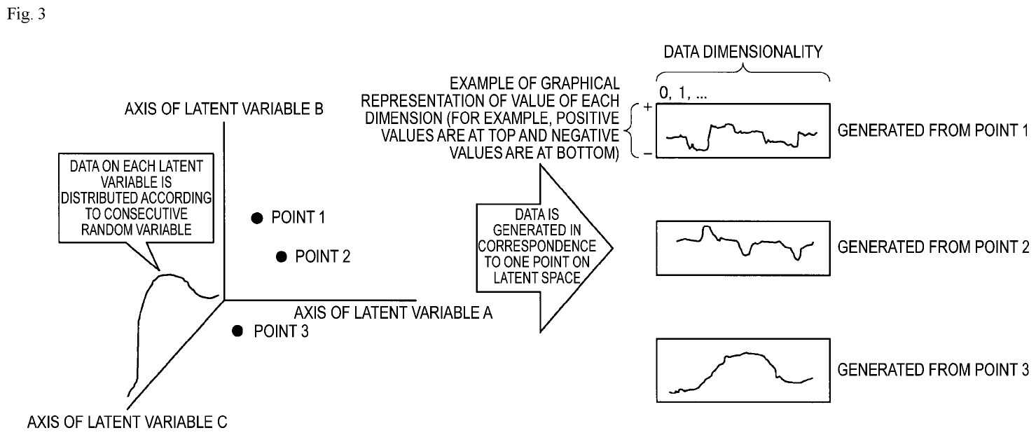

If the process in which sensor data is generated from latent variables can be modeled, it is possible to consider that one sensor data is generated in correspondence to one combination of the latent variables. In the model described above, the data on each latent variable is distributed according to a consecutive random variable. For example, consider the case when sensor data is generated in correspondence to a combination of latent variables A, B, and C. In this case, the latent variable corresponding to the sensor data is expressed as, for example, point 1, point 2, and point 3 on a space (latent space) with an axis of latent variable A, an axis of latent variable B, and an axis of latent variable C as illustrated in FIG. 3. That is, it can be assumed that data (sensor data) is generated in correspondence to one point on the latent space. For example, as illustrated in FIG. 3, point 1, point 2, and point 3 on the latent space correspond to data generated from the latent variable of point 1, data generated from the latent variable of point 2, and data generated from the latent variable of point 3 on the latent space.

Case where InfoGAN is Used as Generative Model

The model construction unit 132 constructs a model that estimates the latent variable from the sensor data, based on a generative model by which sensor data is generated from the latent variable. The generative model is, for example, InfoGAN. Hereinafter, a case in which the model construction unit 132 uses InfoGAN as the generative model will be described.

InfoGAN is an evolved version of a framework of unsupervised learning called GAN, and estimates, from data, a latent variable from which the data is generated.

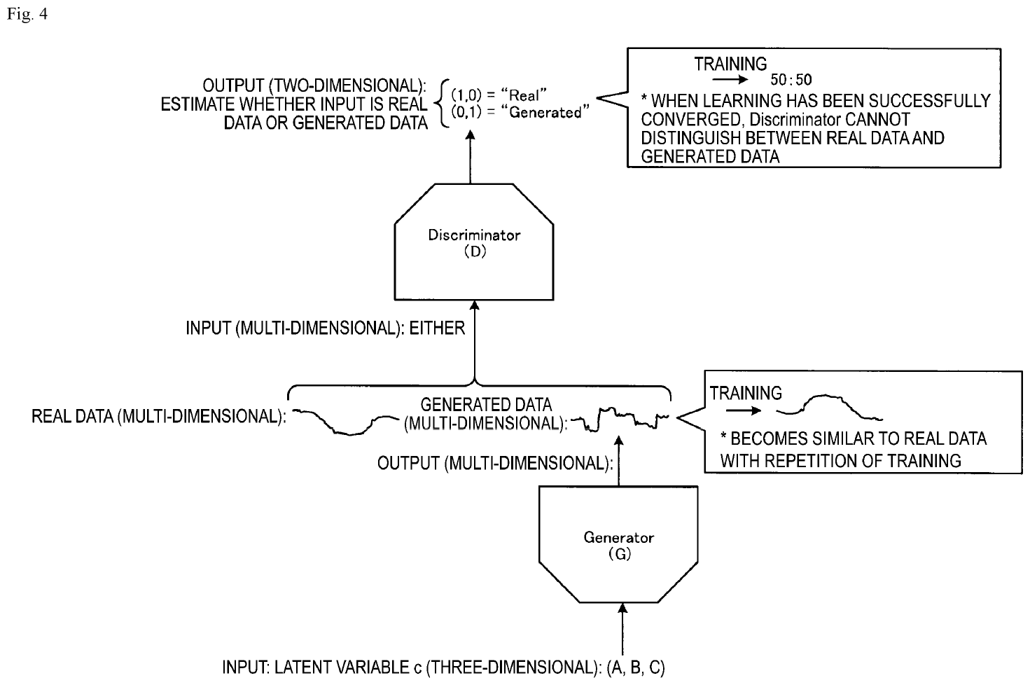

First of all, the GAN will be described. Here, with reference to FIG. 4, an example of a case of modeling the process in which data (sensor data) is generated from a three-dimensional latent variable c (A, B, C) by the GAN will be described. The GAN has a Generator and a Discriminator configured by a neural network.

In response to an input of the three-dimensional latent variable c, Generator (G) generates and outputs multi-dimensional data. In response to an input of either the data generated by the Generator (generated data) or the real data, Discriminator (D) estimates whether the input data is the generated data or real data, and outputs the estimated result. For example, the Discriminator outputs (1,0)=Real (real data) or (0,1)=Generated (generated data) as the estimated result.

In the training of the Generator described above, an evaluation function by which the accuracy of the result of discrimination by the Discriminator between the data generated by the Generator and the real data (data) deteriorates is defined. In the training of the Discriminator, an evaluation function is defined such that the accuracy improves regarding the result of discrimination by the Discriminator between the data generated by the Generator and the real data.

The evaluation functions used in the GAN are expressed by the following equation (1).

$$\begin{matrix}[ Math . 1 ] & \\ {min}_{G} {max}_{D} V ( D , G ) = {x ∼ {P}_{data}}_{} [ log D ( x ) ] + {z ∼ noise}_{} [ log ( 1 - D ( G ( z ) ) ) ] & Equation ( 1 )\end{matrix}$$

By simultaneously (alternately) performing the above-described training of the Generator and training of the Discriminator, the Generator learns to generate data similar to the real data from three latent variables c, with repetition of the training. Furthermore, the Discriminator learns to distinguish the data generated by the Generator and the real data with repetition of the training. When the learning described above has been successfully converged, the Generator is able to generate data that is not distinguishable from the real data. In addition, the Discriminator is not able to distinguish between the real data and the generated data. At this time, it is possible to interpret that the process in which the data is generated from the latent variable has been modeled in the Generator.

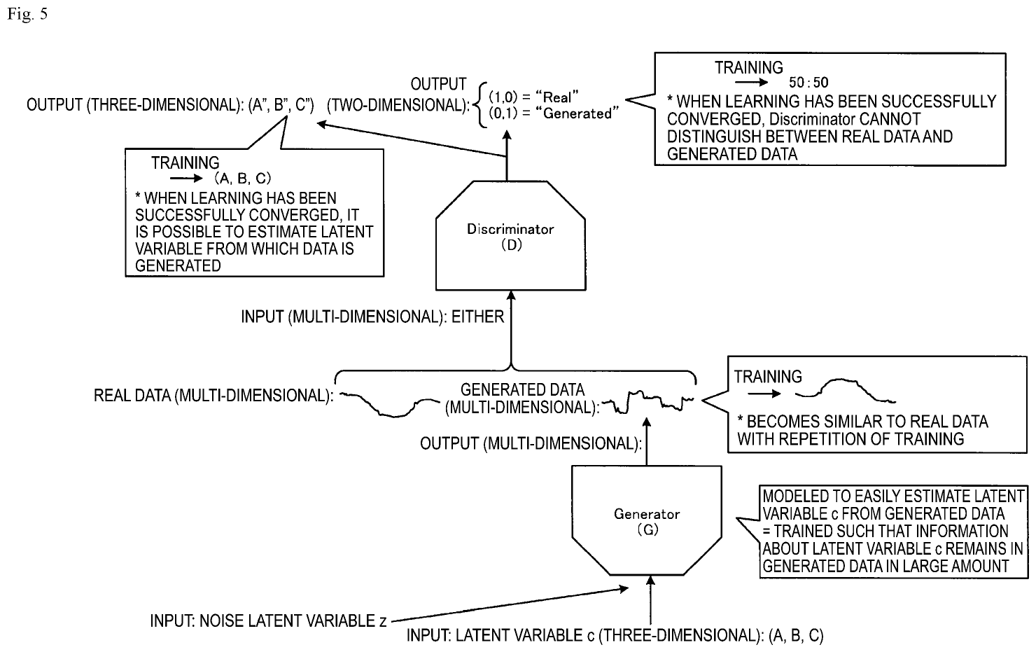

In InfoGAN, a framework of the above-described GAN is evolved to enable estimation of a latent variable from data. With reference to FIG. 5, a case of modeling the process in which data (sensor data) is generated from a three-dimensional latent variable c (A, B, C) in the InfoGAN will be described. For the convenience of the learning process, InfoGAN uses several latent variables (noise latent variable z) describing noise that cannot be interpreted, in addition to the latent variable estimated from the data.

In response to an input of the three-dimensional latent variable c and the noise latent variable z, the Generator (G) generates and outputs multi-dimensional data.

In response to an input of the data generated by the Generator (G) and the real data, the Discriminator (D) estimates whether the input data is the generated data or real data, and outputs the estimated result. For example, the Discriminator outputs (1,0)=Real (real data) or (0,1)=Generated (generated data) as the estimated result. In addition, the Discriminator estimates from which latent variable the generated data is generated.

In the training of the Generator, an evaluation function is defined such that the accuracy deteriorates regarding the result of discrimination by the Discriminator between the data generated by the Generator (generated data) and the real data, and the accuracy improves regarding the result of estimation when the Discriminator estimates from which latent variable the generated data is generated.

In the training of the Discriminator, an evaluation function is defined such that the accuracy improves regarding the result of discrimination by the Discriminator between the data generated by the Generator and the real data, and the accuracy improves regarding the result of estimation when the Discriminator estimates from which latent variable the generated data is generated.

The evaluation functions used in the InfoGAN are expressed by the following equation (2).

$$\begin{matrix}[ Math . 2 ] & \\ {min}_{G} {max}_{D} V ( D , G ) = {x ∼ {P}_{data}}_{} [ log D ( x ) ] + {z ∼ noise}_{} [ log ( 1 - D ( G ( z , c ) ) ) ] - λ I ( c ; G ( z , c ) ) & Equation ( 2 )\end{matrix}$$

With repetition of the training described above, the Generator learns to generate data similar to the real data from the three-dimensional latent variable c and the noise latent variable z, and when the learning has been successfully converged, the Discriminator is not able to distinguish between the real data and the generated data. Also, when learning has been successfully converged, the Discriminator is able to estimate a latent variable from which the data is generated.

At this time, it is possible to interpret that the process in which the data is generated from the latent variable has been modeled in the Generator. Thus, it is possible to interpret that the process in which data is generated from the latent variable is modeled such that when another model estimates the latent variable from the generated data, the process is easy. In other words, in the above process, it is possible to interpret that the mutual information between the latent variable and the generated data is maximized.

That is, according to the learning described above, the Generator is modeled to easily estimate the latent variable c from the generated data. That is, it is possible to interpret that the Generator is trained such that information about the latent variable c remains in the generated data in a large amount.

As a result, the Discriminator is able to estimate from which latent variable the generated data is generated. Thus, by using the above-described trained Discriminator, the clustering apparatus 10 can estimate from which latent variable the real data is generated.

It is noted that the model construction unit 132 may use the GAN described above, or the VAE as a generative model for generating sensor data from a latent variable.

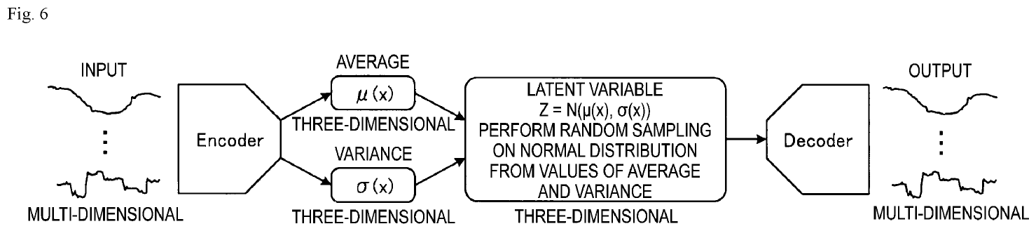

Case Where VAE Is Used As Generative Model Hereinafter, a case in which the model construction unit 132 uses VAE as the generative model will be described with reference to FIG. 6.

VAE is an unsupervised learning machine having an Encoder and a Decoder composed of neural networks. The Encoder is a network that upon the input of multi-dimensional data maps the data to the parameters (average μ(x) and variance σ(x)) of the probability distribution Z for sampling a three-dimensional latent variable, for example. The value of the latent variable is obtained, for example, by performing random sampling on the normal distribution N from the three-dimensional values of the average and variance output from the Encoder.

The Decoder is a network that maps the input values of the three-dimensional latent variable to multi-dimensional data. By performing training so that the output by the Decoder gives restoration of the input, for example, by the backpropagation method, the Encoder learns to estimate the latent variable from which the input multi-dimensional data is generated, and the Decoder learns to model the process of generating sensor data from the latent variable. Thus, by using the Encoder trained as described above, the clustering apparatus 10 is capable of estimating the latent variable from which the data is generated.

Clustering of Latent Variable

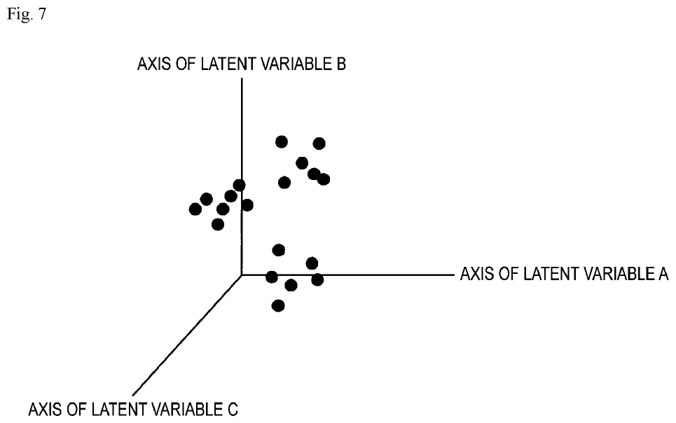

Next, with reference to FIG. 7, the clustering of latent variable by the number-of-clusters identification unit 134 will be described. For example, the number-of-clusters identification unit 134 clusters the estimated values of the latent variable represented by the axes of latent variables A, B, and C illustrated in FIG. 7 by the shallow method, and identifies the optimum number of clusters.

The clustering apparatus 10 limits the number of dimensions of the latent variable from which the sensor data is generated, to a number of dimensions that enables clustering by the shallow method. Thus, the number-of-clusters identification unit 134 is capable of performing clustering of the estimated values of the latent variable by the shallow method.

Also, the number-of-clusters identification unit 134 uses a trial and error approach when identifying the optimum number of clusters, but the applicable computations are much less than when performing trial and error for identifying the optimum number of clusters by the deep method.

Clustering of Sensor Data

The clustering unit 136 clusters the sensor data by the deep method (for example, by a neural network having three or more layers) using the hyperparameter information of the model constructed by the model construction unit 132 and the number of clusters identified by the number-of-clusters identification unit 134. The reasons why the clustering unit 136 is capable of performing clustering of sensor data being discrete data by the above-described clustering are explained below.

As described above, neural networks are utilized for performing clustering by the deep method. If each neural network is trained with the same hyperparameters so as to minimize (maximize) similar evaluation functions for the same data, it is hypothesized that each neural network is trained in a similar manner with a high probability.

For example, in InfoGAN, it is empirically known that similar processing is performed in the following two cases. (1) When learning is performed to estimate a latent variable from which data is generated, and clustering is performed by the shallow method on the latent variable estimated by the Discriminator. (2) When the same hyperparameters and the same data are used, training is performed with a latent variable handled by the Generator being made to be discrete, and the latent variable (a discrete latent variable) estimated by the Discriminator from which the data is generated is considered as a cluster identifier.

Further, for example, in the VAE, there is a high possibility that similar processing is performed in the following two cases. (1) When learning is performed to estimate a latent variable from which data is generated, and clustering is performed by the shallow method on the latent variable estimated by the Encoder. (2) When the same hyperparameters and the same data are used, and the Encoder performs clustering of the latent variable (discrete latent variable) from which the data is generated, by using Deep Clustering (a type of clustering performed by the deep method. See Reference Literature 1).

Reference Literature 1: Deep Clustering for Unsupervised Learning of Visual Features, Mathilde Caron, Piotr Bojanowski; Armand Joulin, Matthijs Douze (ECCV 2018), URL: https://arxiv.org/pdf/1807.05520.pdf

From the above, the clustering unit 136 is capable of performing clustering of sensor data being discrete data, by using the hyperparameter information of the model constructed by the model construction unit 132.

Effects

In this manner, the clustering apparatus 10 first estimates a latent variable from which sensor data is generated, based on a generative model that correlates the latent variable with the sensor data, and determines the optimum number of clusters on the latent variable. In many cases, the optimum number of clusters described above matches the optimum number of clusters when clustering is performed by the deep method using the same data with the same hyperparameters. Thus, the clustering apparatus 10 is capable of performing clustering of sensor data by the deep method, by using the optimum number of clusters described above. As a result, when the clustering apparatus 10 performs clustering of the sensor data, the clustering apparatus 10 need not repeatedly perform the learning process of the neural network in which many computations are required.

As a method of performing clustering by the deep method, there is a method in which the latent variable c of InfoGAN is considered a discrete random variable. For example, if the data is considered to be generated from the latent variable c being any of 0, 1, or 2, the estimation of the latent variable of the data is clustering. However, if the optimum number of clusters is searched by setting a discrete random variable from the beginning, trial and error is performed repeatedly with the deep method.

On the other hand, the clustering apparatus 10 assumes that the latent variable is a consecutive random variable and that data is generated from the latent variable. The consecutive random variable has a higher degree of freedom as compared with a discrete random variable. As a result of the degree of freedom, the number of dimensions of the latent variable initially designated manually need not be as precise as the number of clusters. Note that the number of dimensions of the latent variable is selected as a somewhat large number for the time being from, for example, the numbers of dimensions assumed to be within the range of application of the shallow method. For example, if the number of dimensions of the sensor data is approximately several thousands of dimensions, the number of dimensions of the latent variable is up to approximately several tens of dimensions. As a result, the clustering apparatus 10 is capable of reducing the computations for identifying the optimum number of clusters.

Moreover, because the latent variable obtained by the method described above can be clustered by the shallow method, the clustering apparatus 10 is capable of easily identifying the optimum number of clusters of the latent variable. Here, the inventors empirically discovered the property that the optimum number of clusters identified as described above is also the optimum number of clusters even when clustering is performed by the deep method with the same data and the same hyperparameters. Thus, to utilize the property described above, it was decided to use the optimum number of clusters of the latent variable identified by the method described above as the optimum number of clusters when performing clustering of sensor data by the deep method, in the clustering apparatus 10. As a result, when the clustering apparatus 10 performs clustering of the sensor data, the clustering apparatus 10 need not repeatedly perform the learning process of the neural network to obtain the optimum number of clusters. That is, the clustering apparatus 10 is capable of reducing the computations for identifying the optimum number of clusters. As a result, the clustering apparatus 10 is capable of performing appropriate clustering with less computations for the sensor data.

Program

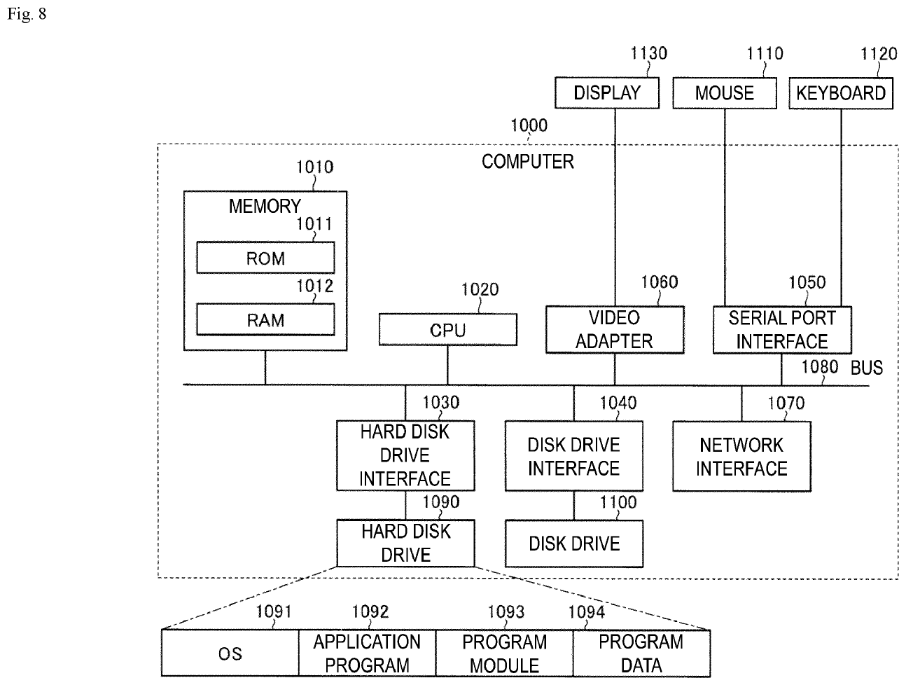

An example of a computer that executes the program (the clustering program) described above will be described with reference to FIG. 8. As illustrated in FIG. 8, a computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. A removable storage medium such as a magnetic disk or an optical disc is inserted into the disk drive 1100. A mouse 1110 and a keyboard 1120, for example, are connected to the serial port interface 1050. A display 1130, for example, is connected to the video adapter 1060.

Here, as illustrated in FIG. 8, the hard disk drive 1090 stores, for example, an OS 1091, an application program 1092, a program module 1093, and program data 1094. The parameters and the like of the model described in the aforementioned embodiment are provided in the hard disk drive 1090 or the memory 1010, for example.

The CPU 1020 reads the program module 1093 and the program data 1094, stored in the hard disk drive 1090, onto the RAM 1012 as needed, and executes each of the aforementioned procedures.

The program module 1093 and the program data 1094 related to the clustering program as described above are not necessarily stored in the hard disk drive 1090 and may be stored in a removable storage medium to be read out by the CPU 1020 via the disk drive 1100 or the like, for example. Alternatively, the program module 1093 and the program data 1094 related to the program described above may be stored in another computer connected via a network such as a LAN or a wide area network (WAN), and may be read by the CPU 1020 via the network interface 1070.

### REFERENCE SIGNS LIST

10 Clustering apparatus
11 Input/output unit
12 Storage unit
13 Control unit
131 Data input acceptance unit
132 Model construction unit
133 Latent variable calculation unit
134 Number-of-clusters identification unit
135 Hyperparameter information acquisition unit
136 Clustering unit

1. A clustering apparatus comprising:
a model construction unit, implemented with one or more processors, configured to construct, on assumption that sensor data is generated from a latent variable, a model for estimating the latent variable from the sensor data, based on a generative model for generating the sensor data from the latent variable, the latent variable being a consecutive random variable of the number of dimensions suitable for handling in unsupervised learning or a neural network having two or less layers;
a latent variable calculation unit, implemented with one or more processors, configured to calculate, from the sensor data, an estimated value of the latent variable from which the sensor data is generated, by using the constructed model;
a number-of-clusters identification unit, implemented with one or more processors, configured to identify the number of clusters when a plurality of the calculated estimated values of the latent variable are clustered by the unsupervised learning or the neural network having two or less layers;
a hyperparameter information acquisition unit, implemented with one or more processors, configured to acquire hyperparameter information of the constructed model; and
a clustering unit, implemented with one or more processors, configured to cluster the sensor data by a neural network having three or more layers, by using the acquired hyperparameter information and the identified number of clusters.

2. The clustering apparatus according to claim 1, wherein the sensor data is one or more of physiological data of a human body, acceleration data indicating a movement of a human body, and rotation amount data indicating a movement of a human body.

3. The clustering apparatus according to claim 1, wherein the consecutive random variable is a random variable in accordance with normal distribution.

4. The clustering apparatus according to claim 1, wherein the generative model is a neural network trained using the unsupervised learning to generate the sensor data from the latent variable.

5. The clustering apparatus according to claim 4, wherein the neural network is either a Generative Adversarial Networks (GAN) or a Variational AutoEncoder (VAE).

6. The clustering apparatus according to claim 1, wherein the number-of-clusters identification unit applies an elbow method to the unsupervised learning or the neural network having two or less layers, in identifying the number of clusters of the sensor data.

7. A clustering method executed by a clustering apparatus comprising one or more processors, the clustering method comprising:
constructing, on assumption that sensor data is generated from a latent variable, a model for estimating the latent variable from the sensor data, based on a generative model for generating the sensor data from the latent variable, the latent variable being a consecutive random variable of the number of dimensions suitable for handling in unsupervised learning or a neural network having two or less layers;
calculating, from the sensor data, an estimated value of the latent variable from which the sensor data is generated, by using the constructed model;
identifying the number of clusters when a plurality of the calculated estimated values of the latent variable are clustered by the unsupervised learning or the neural network having two or less layers;
acquiring hyperparameter information of the constructed model; and
clustering the sensor data by a neural network having three or more layers, by using the acquired hyperparameter information and the identified number of clusters.

8. A non-transitory, computer-readable medium storing one or more instructions, that upon execution, cause a computer system to perform operations comprising:
constructing, on assumption that sensor data is generated from a latent variable, a model for estimating the latent variable from the sensor data, based on a generative model for generating the sensor data from the latent variable, the latent variable being a consecutive random variable of the number of dimensions suitable for handling in unsupervised learning or a neural network having two or less layers;
calculating, from the sensor data, an estimated value of the latent variable from which the sensor data is generated, by using the constructed model;
identifying the number of clusters when a plurality of the calculated estimated values of the latent variable are clustered by the unsupervised learning or the neural network having two or less layers;
acquiring hyperparameter information of the constructed model; and
clustering the sensor data by a neural network having three or more layers, by using the acquired hyperparameter information and the identified number of clusters.
